(19) United States
(12) Patent Application Publication
(10) Pub. No.: US 2002/0037703 A1
(43) Pub. Date: Mar. 28, 2002

(54) Telephone

(76) Inventors: Kashichi Hirota, Tokyo (JP); Junji Fukuda, Tokyo (JP)

Correspondence Address: JACOBSON HOLMAN PLLC, 400 SEVENTH STREET N.W., SUITE 600, WASHINGTON, DC, 20004, US

(21) Appl. No.: 09/768,615

(22) Filed: Jan. 25, 2001

(30) Foreign Application Priority Data
Jun. 26, 2000 (JP) 190740/2000
Jun. 26, 2000 (JP) 191001/2000

(51) Int. Cl. H04Q 7/20

(52) U.S. Cl. 455/90; 455/433; 455/428

(57) ABSTRACT

A telephone comprises a body formed of a plastic material, wherein at least part of the body includes a section formed of a transparent material. An adhesive layer is provided on the rear face of the section formed of the transparent material, and colored or lustrous fine fragments are dispersedly applied onto the adhesive layer. A painting layer is also provided on the colored or lustrous fine fragments. As to painting, metallic coating may be applied as well as regular painting.

### TECHNICAL FIELD

The present invention relates to a telephone, more particularly to a body structure of a telephone.

### BACKGROUND ART

Various efforts have been made to provide an improved appearance of frames associated with display screens of television receivers and personal computers by finishing them in lustrous form. Earning popularity to such approaches has incrementally motivated the similar trend in other products, unexceptionally in telephones. Typically, products having desired lustrous appearance cannot be achieved only by applying paint once, and are ordinarily required to apply paint once and then coat with clear paint with luster thereon. However, due to an essential proposition for the telephones to be inexpensive, such a conventional technique as-is cannot be employed in the telephones.

In recent years, most telephones have a display on the top face thereof. The display typically comprises a display panel of a liquid crystal display panel, and a transparent guard plate disposed outside the display panel with leaving a space therebetween. The display serves to indicate the other end's telephone number dial-input in call, and otherwise to indicate variously in each case.

With respect to the large volume of information indicated on the display, the display has an insufficient size of the display panel, and often suffers from poor visibility of these indications. Particularly in a portable telephone, the size of its display panel is extremely small, and characters indicated on the display panel inevitably become smaller, resulting in a difficulty of reading the indication.

As the recent trend, many portable telephones have applied a colored display panel, or a colored transparent guard plate to enhance competitive ability of products. However, since the portable telephone inherently has a small size as a whole, there is a limit to yield an ornamental function to the telephone itself. Particularly at night, it is also hard to find out the portable telephone due to its unspecific location to be placed.

### DISCLOSURE OF THE INVENTION

It is one object of the present invention to achieve an improved telephone which is inexpensive and has an ornamental function out of an appearance with lustrous finish.

It is another object of the present invention to provide an improved telephone which allows user to readily find out it even in the night.

More specifically, the primary object of the present invention is to solve or drastically relieve the problem in which a telephone having a display heretofore has suffered from the difficulty of reading the indication on the display.

In order to achieve the aforementioned object, there is provided a telephone according to the present invention, comprising a body formed of a plastic material, wherein at least part of the body includes a section formed of a transparent material, an adhesive layer provided on the rear face of the section formed of the transparent material, colored or lustrous fine fragments dispersedly applied onto the adhesive layer, and a painting layer provided on the colored or lustrous fine fragments. As to painting, metallic coating or painting may be applied as well as regular painting.

In a telephone according to another aspect of the present invention, at least part of a body includes a section formed of a transparent material, and a luminous material is mixed in the section formed of the transparent material by a predetermined ratio, for example the ratio of from 5% to 10%.

According to yet another aspect the present invention, at least part of a body includes a section formed of a colored or colorless transparent material, and fine powders of colored or lustrous materials are dispersedly included in the section formed of the transparent material. The fine powders are preferably formed of metallic foil or paper.

According to still another aspect of the present invention, a body of a telephone comprises a display including a display panel and a transparent guard plate disposed outside the display panel with leaving a space to the display panel. The transparent guard plate includes a transparent section corresponding to the display panel and a peripheral section around the transparent section, the peripheral section being coated with paint. This painting layer is formed by applying a luminous paint. This structure allows user to readily recognize the location of the telephone even in dark circumstance, and provides a significantly convenient advantage particularly in the portable telephones. The telephone according to this aspect may utilize the peripheral section of the transparent guard plate of the display for ornamental purpose, and enables to readily achieve an enhanced ornamental function at a low cost.

In a telephone according to still a further aspect of the present invention, a transparent guard plate comprises a transparent section corresponding to a display panel and a peripheral section around the transparent section, wherein the peripheral section is formed of a transparent material, an adhesive layer provided on the rear face of the peripheral section, colored or lustrous fine fragments dispersedly applied on the adhesive layer, and a painting layer provided on the colored or lustrous fine fragments. The peripheral section has a front face formed in a lustrous surface obtained from the front face of the transparent guard plate, and the colored or lustrous fine fragments and the painting layer can be seen through the transparent guard plate, so that the external appearance is improved. In addition, since regular paints may be applied as this paint, the painting layer may be formed at a significantly lower cost than that of the conventional painting process using the luster paint.

According to another still further aspect of the present invention, a peripheral section of a transparent guard plate is formed of a colored or colorless transparent material, and fine powders of a colored or lustrous material are dispersedly included in the section formed of the transparent material. In this case, fine powders are preferably formed of metallic foil or paper.

In a telephone according to an additional aspect of the present invention, a transparent guard plate comprises a transparent section corresponding to a display panel, a peripheral section around the transparent section, wherein the transparent section including a front face and a rear face facing the display panel, the front face being formed as a convex lens having a convex surface, the rear face being formed as a Fresnel lens having a convex lens function, and the peripheral section being coated with paint. The painting layer may be formed by applying regular paints or through silk-screening process. Using a luminous paint to form the painting layer enables user to readily recognize the location of the telephone even in dark circumstance, and provides a significantly convenient advantage particularly in the portable telephones. The telephone according to this aspect may utilize the peripheral section of the transparent guard plate of a display for ornamental purpose, and enables to readily achieve an enhanced ornamental function at a low cost.

According to yet an additional aspect of the present invention, the transparent guard plate comprises a transparent section corresponding to a display panel and a peripheral section around the peripheral section, wherein the peripheral section is formed of a transparent material, an adhesive layer provided on the rear face of the peripheral section, colored or lustrous fine fragments dispersedly applied on the adhesive layer, and a painting layer provided on the colored or lustrous fine fragments. In this case, the transparent section corresponding to the display panel may include a front face and a rear face facing the display panel, the front face being formed in a convex lens, the rear face being formed in a Fresnel lens having a convex lens function. The peripheral section has the front face formed in a lustrous surface obtained from the front face of the transparent guard plate, and the colored or lustrous fine fragments and the painting layer can be seen through the transparent guard plate, so that the external appearance is improved. In addition, since regular paints may be applied as this paint, the painting layer may be formed at a significantly lower cost than that of the conventional painting process using the luster paint.

### BRIEF DESCRIPTION OF TEH DRAWINGS

FIG. 1 is a perspective view showing a portable telephone according to one embodiment of the present invention;

FIG. 2 is a front view of the portable telephone shown in FIG. 1;

FIG. 3 is a perspective view showing a state where a transparent guard plate is taken out from the portable telephone shown in FIG. 1;

FIG. 4 is a partially sectional side view of the portable telephone shown in FIG. 1;

FIG. 5 is a front view of a transparent guard plate used in the portable telephone shown in FIG. 1;

FIG. 6 is a sectional view of the transparent guard plate;

FIG. 7 is a partially enlarged sectional view of the transparent guard plate;

FIG. 8 is a sectional view showing another embodiment according to the present invention similar to FIG. 7;

FIG. 9 is a sectional view showing yet another embodiment according to the present invention; and

FIG. 10 is a sectional view showing still another embodiment according to the present invention.

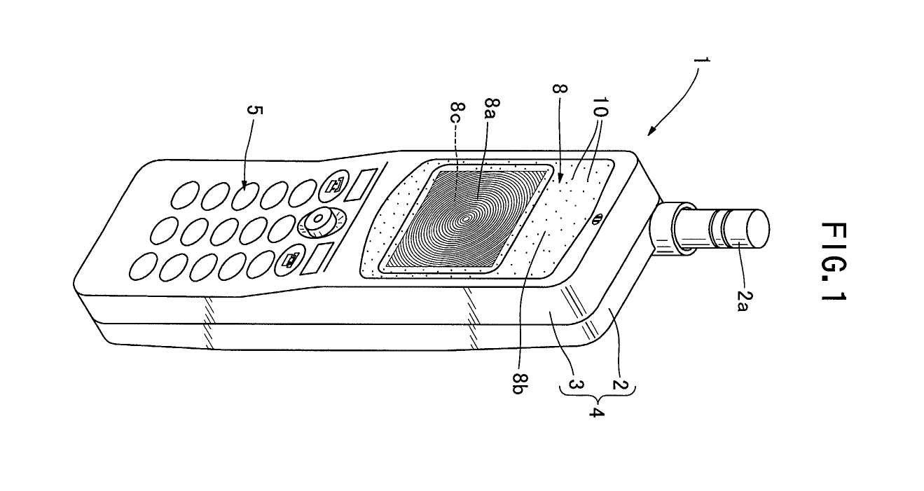

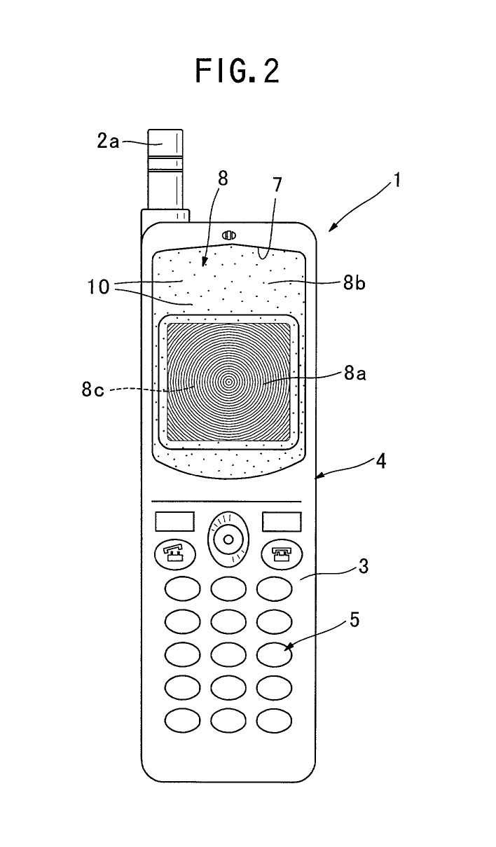

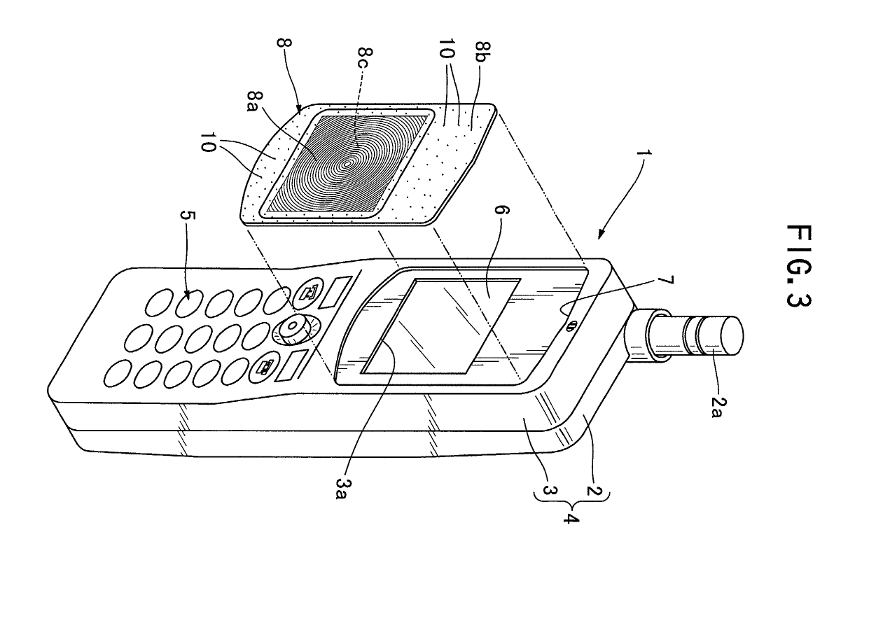

### DETAILED DESCRIPTION OF THE PREFERRED EMBODIMENTS

Preferred embodiments of the present invention will now be described with reference to the drawings. Figures show examples in which the present invention is embodied in a portable telephone. A portable telephone 1 as shown in figures comprises a telephone body 4 composed of a rear body 2 and a front body 3, which are formed by molding a plastic or resin material, such as acrylic, polycarbonate, or ABS resin. The rear body 2 is provided with an antenna 2a extensible upward. Operating buttons 5, such as dials, are arranged on the front body 3 as in a regular portable telephone.

The front body 3 has a rectangular display window 3a on which a liquid crystal display panel 6 is placed. A recessed section 7 is formed in the area surrounding the display window 3a of the front body 3, and a transparent guard plate 8 is fitted into the recessed section 7. While the transparent guard plate 8 is preferably formed of a plastic material, such as acrylic resin or polycarbonate, it is apparent that other suitable transparent materials may be applied to form the transparent guard plate 8.

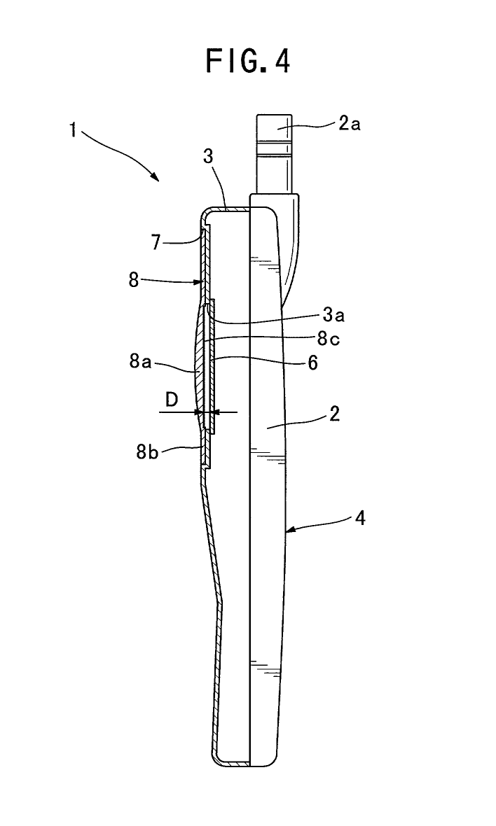

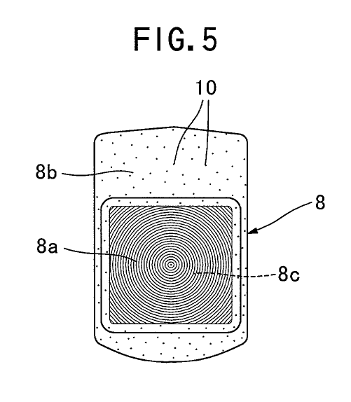

In the embodiment shown in the figures, the guard plate 8 includes a transparent section 8a having an approximate same size and shape as the display panel 6 in the position corresponding to the display panel 6 disposed on the display window 3a of the front body 3, and a peripheral section 8b around the transparent section 8a. As shown in FIG. 4, the transparent section 8a is disposed with leaving a predetermined distance D from the surface of the display panel 6. In the illustrated example, the distance D is about 3 mm.

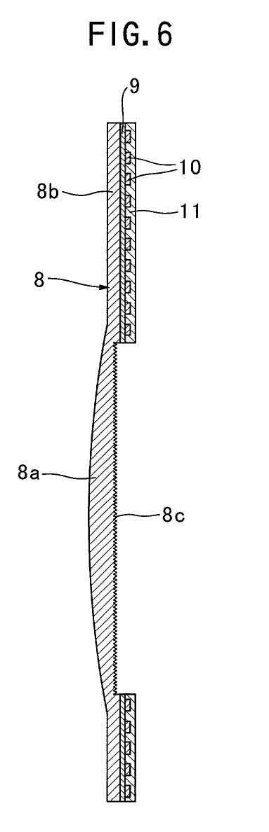

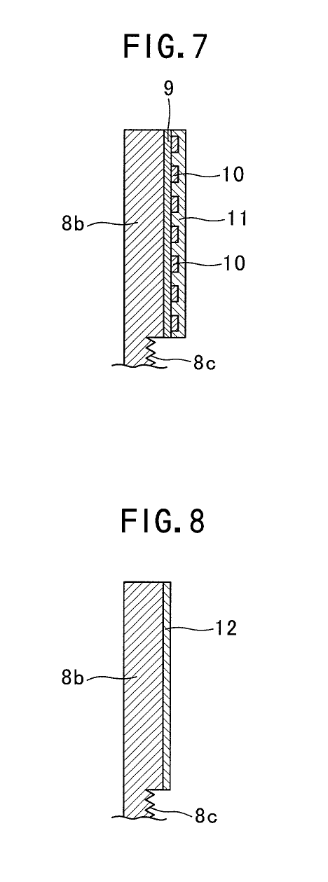

As shown in FIG. 6, the front face of the transparent section 8a forms a convex lens having a convex spherical surface. In the case where the display panel has a dimension of about 30 mm×23 mm as in the regular portable telephone and apply the aforementioned plastic materials, and the thickness of the central section of the lens is arranged in about 3 mm in consideration of portability as the portable telephone, a focal distance of the convex lens will be about 124 mm. Thus, when the above-mentioned distance D is arranged in 3 mm, about 2.5% of magnifying power can be obtained only by the convex lens of the front face.

A concentric-circle Fresnel lens 8c having a spherical convex lens function is formed in the rear face of the transparent section 8a of the guard plate 8. The Fresnel lens 8c is positioned to make its optical center approximately lay on the graphic center of the display panel 6. In order to maintain the visibility for characters and symbols indicated on the display panel 6, it is desired to construct the Fresnel lens 8 with the smallest Fresnel pitch possible. The desired Fresnel pitch of the Fresnel lens is 0.2 mm or less. The magnifying power as a whole may be enhanced by the combined effect of the Fresnel lens 8c and the convex lens of the front face. According to a provisional calculation by the inventors, about 7.5% of magnifying power may be expected.

An adhesive layer 9 is formed on the rear face of the peripheral section 8b of the transparent guard plate 8. On the adhesive layer 9, fine fragments or particles 10, such as lustrous metallic foils or papers, or pieces of colored paper, are dispersedly applied, and a painting layer 11 of an regular paint is then formed on the fine fragments 10. When seen from the front side, the material of the transparent guard plate 8 composing the peripheral section 8b forms a lustrous front surface, and the color of the painting layer 11 and the fine fragments 10 dispersedly applied on the painting layer 11 can be seen through the front face, so that its appearance similar to that by the painting process using luster paint, i.e. lustrous painting, can be obtained. Thus, the painting layer 11 can be formed at a lower price than the lustrous painting and has a high practicability.

As shown by 12 in FIG. 8, the rear face of the peripheral section 8b of the transparent guard plate 8 may be coated with a regular paint instead of the adhesive layer 9, the fine fragments 10, and the painting layer 11, described above. In this case, a luminous paint can be applied as the paint. Specifically, the telephone body may be adapted to absorb energy through the stimulation of sunlight or fluorescent light so as to emit light even in the night by making 5% to 10% by weight of a luminous material include in the paint. Employing this structure allows user to readily find out the telephone even in the darkness at night, and provide a convenient advantage in the portable telephone.

Further, in another embodiment of the present invention, a construction having lustrous fine powders dispersedly arranged in the peripheral section 8b may be provided by mixing metal powders, such as aluminum powders or copper powders, in the transparent plastic materials forming the peripheral section 8b, and then forming through the injection molding process. In this case, the transparent plastic material is colored, or the rear face of the peripheral section is colored through the silk-screening process.

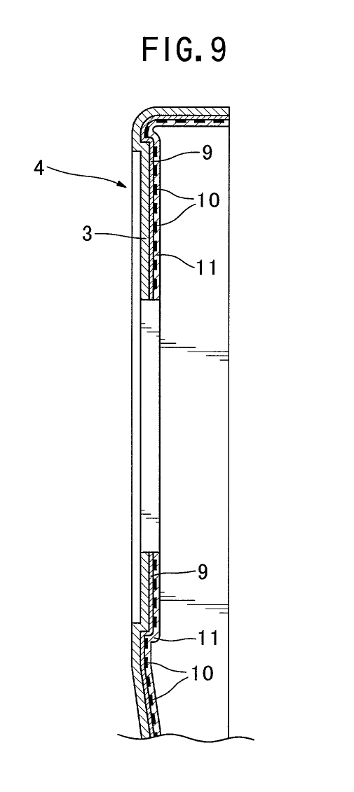

FIG. 9 is a sectional view showing yet another embodiment according to the present invention. In this embodiment, the front body 3 of the telephone body 4 is formed of a transparent plastic material. The adhesive layer 9 is formed on the rear face of the front body 3, and fine fragments 10, such as lustrous metallic foil or paper, or colored paper pieces, are dispersedly arranged on the adhesive layer 9. The coating layer 11 is then formed on the fine fragments 10 by using a regular paint. The same construction may be applied to the rear body 2 of the telephone body 4.

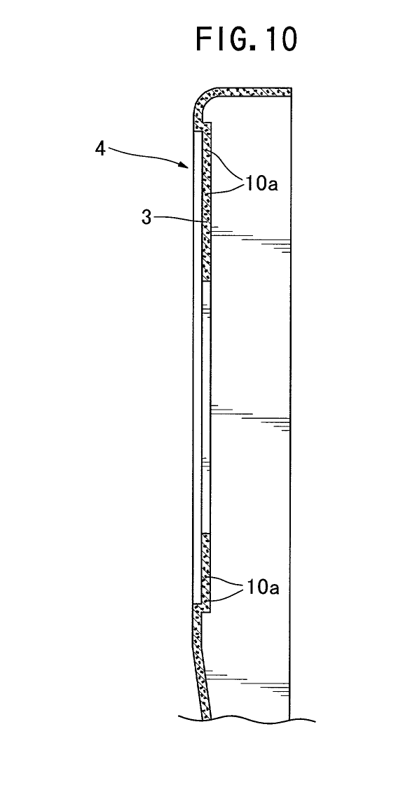

FIG. 10 shows still another embodiment, in which the front body 3 of the telephone body 4 is formed of a transparent plastic material, such as colored or colorless acrylic material or polycarbonate. 3 to 5% by weight of fine powders 10a of metallic materials, such as aluminum or copper are mixed in the transparent plastic material, and the front body 3 is formed through the injection molding process with this plastic material. The same construction may be applied to the rear body 2 of the telephone body 4. The telephone body constructed as described above shows an distinguished appearance with a lustrous external surface and a brilliance of the fine powders 10a of metallic material, so that an ornamental blazonry may be yielded from outside. When the transparent plastic materials are colorless or light-colored, the rear face may be colored by painting or printing.

Further, in the present invention, the front body 3 or both of the front body 3 and the rear body 2 of the telephone body 3 may be formed of a transparent plastic material, and the rear face of the transparent plastic material may be coated with a luminous paint. As an alternative construction, the telephone body may be adapted to absorb energy through the stimulation of sunlight or fluorescent light so as to emit light even in the night by making 5% to 10% by weight of a luminous material include in the paint.

While the embodiments of the present invention have been described in connection with the portable telephone, the present invention may be applied to any type of telephones.

1. A telephone comprising:
a body formed of a plastic material, wherein at least part of said body includes a section formed of a transparent material;
an adhesive layer provided on the rear face of said section formed of said transparent material;
colored or lustrous fine fragments dispersedly applied onto said adhesive layer; and
a painting layer provided on said colored or lustrous fine fragments.

2. A telephone comprising:
a body formed of a plastic material, wherein at least part of said body includes a section formed of a transparent material; and
a luminous material mixed in said section formed of said transparent material by a predetermined ratio.

3. A telephone comprising:
a body formed of a plastic material, wherein at least part of said body includes a section formed of a transparent material; and
a painting layer formed on the rear face of said section formed of said transparent material, said painting layer including a luminous material.

4. A telephone comprising:
a body formed of a plastic material, wherein at least part of said body includes a section formed of a colored or colorless transparent material; and
fine powders of colored or lustrous materials dispersedly included in said section formed of said transparent material.

5. A telephone comprising:
a display having a display panel;
a transparent guard plate disposed outside said display panel with leaving a space to said display panel, wherein said transparent guard plate includes a transparent section corresponding to said display panel and a peripheral section around said transparent section, said peripheral section being formed of a transparent material;
an adhesive layer provided on the rear face of said peripheral section;
colored or lustrous fine fragments dispersedly applied onto said adhesive layer; and
a painting layer provided on said colored or lustrous fine fragments.

6. A telephone comprising:
a display having a display panel;
a transparent guard plate disposed outside said display panel with leaving a space to said display panel, wherein said transparent guard plate includes a transparent section corresponding to said display panel and a peripheral section around said transparent section, said peripheral section being formed of a transparent material; and
a painting layer formed on the rear face of said peripheral section, said painting layer including a luminous material.

7. A telephone comprising:
a display having a display panel;
a transparent guard plate disposed outside said display panel with leaving a space to said display panel, wherein said transparent guard plate includes a transparent section corresponding to said display panel and a peripheral section around said transparent section, said peripheral section being formed of a transparent material; and
fine powders of colored or lustrous materials dispersedly included in said section formed of said transparent material.

8. A telephone comprising:
a display having a display panel;
a transparent guard plate disposed outside said display panel with leaving a space to said display panel, wherein said transparent guard plate includes a transparent section corresponding to said display panel and a peripheral section around said transparent section, said peripheral section being formed of a transparent material;
an adhesive layer provided on the rear face of said peripheral section;
colored or lustrous fine fragments dispersedly applied onto said adhesive layer; and
a painting layer provided on said colored or lustrous fine fragments,
wherein said transparent section including a front face and a rear face facing said display panel, said front face being formed as a convex lens having a convex surface, said rear face being formed as a Fresnel lens having a convex lens function.

9. A telephone as defined in either one of claims 1, 4 and 7, wherein said colored or lustrous fine powders are formed of metallic foil.

10. A telephone as defined in either one of claims 1 to 9, wherein said telephone is a portable telephone.
